(19) United States
(12) Patent Application Publication
(10) Pub. No.: US 2025/0207266 A1
(43) Pub. Date: Jun. 26, 2025

(54) CONTROL DEVICE FOR WATER ELECTROLYSIS CELL, WATER ELECTROLYSIS SYSTEM, AND CONTROL METHOD FOR WATER ELECTROLYSIS CELL

(71) Applicant: ENEOS Corporation, Chiyoda-ku, Tokyo (JP)

(72) Inventors: Ichiro OKUMO, Chiyoda-ku, Tokyo (JP); Hirofumi TAKAMI, Chiyoda-ku, Tokyo (JP); Yasushi SATO, Chiyoda-ku, Tokyo (JP)

(73) Assignee: ENEOS Corporation, Chiyoda-ku, Tokyo (JP)

(21) Appl. No.: 18/851,614

(22) PCT Filed: Mar. 1, 2023
(86) PCT No.: PCT/JP2023/007598

§ 371 Date: Sep. 26, 2024

(30) Foreign Application Priority Data
Mar. 29, 2022 (JP) 2022-053905

(51) Int. Cl. C25B 1/04; C25B 9/19; C25B 15/02

(52) U.S. Cl. CPC C25B 1/04; C25B 9/19; C25B 15/02

(57) ABSTRACT

A water electrolysis cell has: an oxygen generating electrode; a hydrogen generating electrode; and a membrane, and electrolyzes water to generate oxygen on the oxygen generating electrode and generate hydrogen on the hydrogen generating electrode. A control device includes: a potential-maintaining mode where the water electrolysis cell is supplied with electric current; and a complete stop mode where the water electrolysis cell is shut out from electric current supply, each of the modes is optionally implemented during an operation stop, wherein which of the modes is implemented is determined based on a duration time of the operation stop, a first deterioration rate of the water electrolysis cell when the complete stop mode is implemented, and a second deterioration rate of the water electrolysis cell when the potential-maintaining mode is implemented.

### CROSS-REFERENCE TO RELATED APPLICATIONS

This application is based upon and claims the benefit of priority from the prior Japanese Patent Application No. 2022-053905, filed on Mar. 29, 2022, and the International Patent Application No. PCT/JP2023/007598, filed on Mar. 1, 2023, the entire content of each of which is incorporated herein by reference.

### BACKGROUND

### Field of the Invention

The present invention relates to: a control device for a water electrolysis cell, a water electrolysis system, and a control method for a water electrolysis cell.

### Description of the Related Art

Conventionally, as a hydrogen-generating device, an electrochemical device using an ion exchange membrane made of solid polymer has been devised. In this electrochemical device, water is supplied to the anode or both electrodes, and at the same time, electric current is applied between the electrodes. Thereby, oxygen and hydrogen are obtained through water electrolysis. For such an electrochemical device, it has been known that the electrodes can deteriorate particularly during operation stop (see Patent Literature 1).
Patent Literature 1: JP H1-222082 A

In recent years, renewable energy obtained by wind power, sunlight, or the like has attracted attention as energy capable of suppressing carbon dioxide emission in the power generation process as compared with energy obtained by thermal power generation. In addition, as a part thereof, hydrogen production utilizing renewable energy has been studied. As a system for realizing the hydrogen production, a water electrolysis system using the above-described electrochemical device is being developed. However, in a power generator using wind power or sunlight, the output fluctuates frequently, and the output becomes zero under no wind or depending on the weather. Therefore, when a power generator using wind power or sunlight is used as a power supply, the electrochemical device frequently repeats stop and start. Therefore, the electrochemical device irregularly stops to deteriorate the electrodes, and durability of the water electrolysis system can be deteriorated.

### SUMMARY OF THE INVENTION

The present invention has been made in view of such a situation, and an object of the present invention is to provide a technique for improving the durability of the water electrolysis system.

An embodiment of the present invention is a control device for a water electrolysis cell that has: an oxygen generating electrode containing an oxygen generating catalyst; a hydrogen generating electrode containing a hydrogen generating catalyst; and a membrane that separates the oxygen generating electrode and the hydrogen generating electrode, and electrolyzes water to generate oxygen on the oxygen generating electrode and generate hydrogen on the hydrogen generating electrode. The control device includes: a potential-maintaining mode where at least one of the water electrolysis cell(s) is supplied with electric current; and a complete stop mode where the water electrolysis cell is shut out from electric current supply, each of the modes is optionally implemented during an operation stop where the water electrolysis cell stops hydrogen supply, wherein which of the modes is implemented is determined based on a duration time of the operation stop, a first deterioration rate of the water electrolysis cell when the complete stop mode is implemented, and a second deterioration rate of the water electrolysis cell when the potential-maintaining mode is implemented.

Another embodiment of the present invention is a water electrolysis system. The system includes at least one water electrolysis cell and the control device for a water electrolysis cell of the above embodiment.

Another embodiment of the present invention is a control method for a water electrolysis cell. The control method includes: determining which of: a potential-maintaining mode where at least one of the water electrolysis cell(s) is supplied with electric current; and a complete stop mode where the water electrolysis cell is shut out from electric current supply is implemented during an operation stop where the water electrolysis cell stops hydrogen supply, based on a duration time of the operation stop, a first deterioration rate of the water electrolysis cell when the complete stop mode is implemented, and a second deterioration rate of the water electrolysis cell when the potential-maintaining mode is implemented.

Any combination of the above components and any modification of the expressions of the present disclosure among methods, apparatuses, systems, and the like are also effective as an embodiment of the present disclosure.

### BRIEF DESCRIPTION OF DRAWING

Embodiments will now be described, by way of example only, with reference to the accompanying drawings which are meant to be exemplary, not limiting, and wherein like elements are numbered alike in several Figures, in which:

FIG. 1 is a schematic diagram of a water electrolysis system according to an embodiment.

### DETAILED DESCRIPTION OF THE INVENTION

Hereinafter, the present invention will be described based on preferred embodiments with reference to the drawing. The embodiments are not intended to limit the technical scope of the present invention but are examples, and all features described in the embodiments and combinations thereof are not necessarily essential to the invention. Therefore, the contents of the embodiments can be subjected to many design changes such as changes, additions, and deletions of components without departing from the spirit of the invention defined in the claims. A new embodiment to which a design change is made has the effect of each of the combined embodiments and the modifications.

In the embodiments, the contents capable of such a design change are emphasized with notations such as “of the embodiment” and “in the embodiment”, but the design change is allowed even in the contents without such notations. Any combination of the components described in the embodiments is also effective as an embodiment of the present invention. The same or equivalent components, members, and processes illustrated in the drawing are denoted by the same sign, and redundant descriptions will be omitted as appropriate. In addition, the scale and shape of each part illustrated in the drawing are set for convenience in order to facilitate descriptions, and are not limitedly interpreted unless otherwise specified. In addition, when the terms “first”, “second”, and the like are used in the present specification or claims, the terms do not represent any order or importance, but are used to distinguish one configuration from another. In addition, in the drawing, some members that are not important for describing the embodiment are omitted.

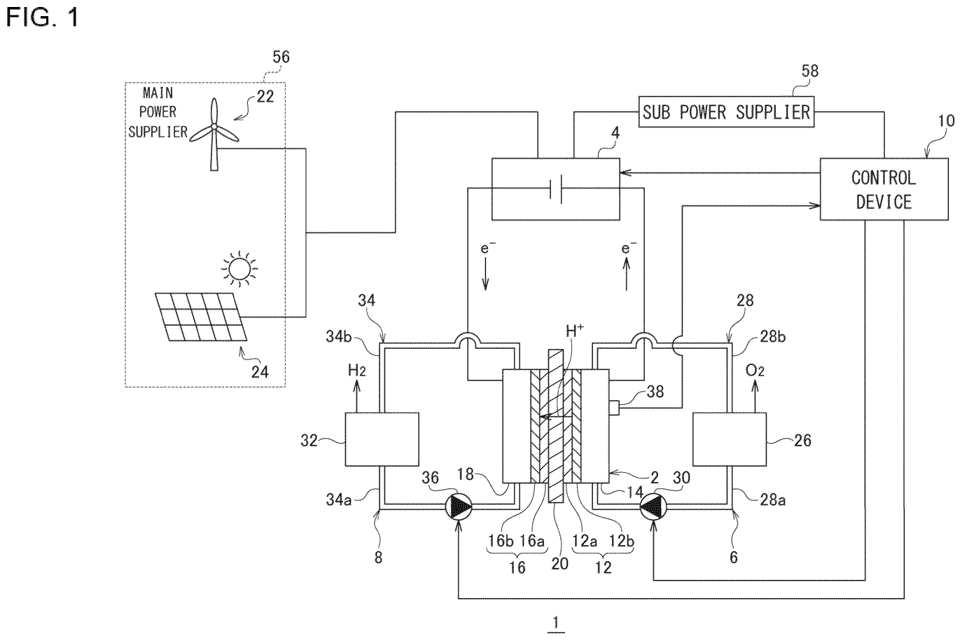

FIG. 1 is a schematic diagram of a water electrolysis system 1 according to an embodiment. The water electrolysis system 1 includes a water electrolysis cell 2, a power supply 4, a first flow mechanism 6, a second flow mechanism 8, and a control device 10. The water electrolysis system 1 may include a water electrolysis stack in which a plurality of the water electrolysis cells 2 are stacked.

The water electrolysis cell 2 generates oxygen and hydrogen by water electrolysis. The water electrolysis cell 2 of the embodiment is a solid polymer film (PEM: Polymer Electrolyte Membrane) type water electrolysis cell using an ion exchange membrane. The water electrolysis cell 2 includes an oxygen generating electrode 12, a hydrogen generating electrode 16, and a membrane 20.

The oxygen generating electrode 12 is an electrode where an oxidation reaction occurs and is defined as a positive electrode (anode). The oxygen generating electrode 12 includes a catalyst layer 12a and a gas diffusion layer 12b. The catalyst layer 12a contains, for example, iridium (Ir) or platinum (Pt) as an oxygen generating catalyst. The catalyst layer 12a may contain other metals or metal compounds. The catalyst layer 12a is disposed in contact with one main surface of the membrane 20. The gas diffusion layer 12b is formed of a conductive porous body or the like. As a material constituting the gas diffusion layer 12b, a known material can be used. The oxygen generating electrode 12 is equipped in an oxygen generating electrode chamber 14. The space excluding the oxygen generating electrode 12 in the oxygen generating electrode chamber 14 constitutes a flow path of water and oxygen.

The hydrogen generating electrode 16 is an electrode where a reduction reaction occurs and is defined as a negative electrode (cathode). The hydrogen generating electrode 16 includes a catalyst layer 16a and a gas diffusion layer 16b. The catalyst layer 16a contains, for example, platinum (Pt) as a hydrogen generating catalyst. The catalyst layer 16a may contain other metals or metal compounds. The catalyst layer 16a is disposed in contact with the other main surface of the membrane 20. The gas diffusion layer 16b is formed of a conductive porous body or the like. As a material constituting the gas diffusion layer 16b, a known material can be used. The hydrogen generating electrode 16 is equipped in a hydrogen generating electrode chamber 18. The space excluding the hydrogen generating electrode 16 in the hydrogen generating electrode chamber 18 constitutes a flow path of water and hydrogen.

The oxygen generating electrode 12 and the hydrogen generating electrode 16 are separated by the membrane 20. The membrane 20 of the embodiment is made of a solid polymer electrolyte membrane. The solid polymer electrolyte membrane is not particularly limited as long as it is a material through which protons (H*) conduct, and examples thereof include a fluorine-based ion exchange membrane having a sulfonate group.

The reaction during water electrolysis in the water electrolysis cell 2 is as follows.

2H₂O→O₂+4H⁺+4e⁻ Anode reaction during electrolysis

4H⁺+4e⁻→2H₂ Cathode reaction during electrolysis

2H₂O→O₂+2H₂ Total reaction during electrolysis

On the oxygen generating electrode 12, water is electrolyzed to generate oxygen gas, protons, and electrons. The protons move through the membrane 20 toward the hydrogen generating electrode 16. The electrons flow into the positive electrode of the power supply 4. The oxygen gas is discharged to the outside from the oxygen generating electrode chamber 14. On the hydrogen generating electrode 16, hydrogen gas is generated by a reaction between electrons supplied from the negative electrode of the power supply 4 and protons having moved through the membrane 20. The hydrogen gas is discharged to the outside from the hydrogen generating electrode chamber 18.

The power supply 4 is a DC power supply that supplies power to the water electrolysis cell 2. When power is supplied from the power supply 4, a predetermined electrolysis voltage is applied between the oxygen generating electrode 12 and the hydrogen generating electrode 16, and water electrolysis electric current flows. That is, water electrolysis electric current is supplied from the power supply 4 to the water electrolysis cell 2. As an example, the power supply 4 is supplied with power from a main power supplier 56 and a sub power supplier 58, and applies a voltage to the water electrolysis cell 2.

The main power supplier 56 can include a wind power generator 22, a solar power generator 24, or the like that generates power derived from renewable energy. The main power supplier 56 is not limited to a power generator that generates power derived from renewable energy. The water electrolysis system 1 is in operation when the water electrolysis electric current is supplied to the water electrolysis cell 2 (when the water electrolysis electric current flows in the water electrolysis cell 2), and is in an operation stop when water electrolysis electric current supply to the water electrolysis cell 2 is stopped. The term “operation” means that hydrogen is generated and supplied to the outside of the water electrolysis system 1, which is a main object of the water electrolysis system 1. Therefore, the term “operation stop” means that hydrogen supply from the water electrolysis cell 2 to the outside is stopped.

In the embodiment, the water electrolysis system 1 is in operation when power from the main power supplier 56 is supplied to supply water electrolysis electric current to the water electrolysis cell 2, and the water electrolysis system 1 is in the operation stop when less power from the main power supplier 56 is supplied to stop water electrolysis electric current supply to the water electrolysis cell 2. Therefore, even when the water electrolysis system 1 is in the operation stop, power supply from the sub power supplier 58 or the like may be performed.

The phrase “to stop water electrolysis electric current supply” means, for example, that the voltage state of the water electrolysis cell 2 is lower than the theoretical water electrolysis voltage. The theoretical water electrolysis voltage is calculated from the difference between: the oxidation-reduction potential based on Gibbs free energy (ΔG) in the hydrogen generation reaction (cathode reaction) by reduction of protons; and the oxidation-reduction potential based on ΔG in the oxygen generation reaction (anode reaction) by decomposition of water. Specifically, the oxidation-reduction potential in the cathode reaction is 0 V based on ΔG. The oxidation-reduction potential in the anode reaction is 1.23 V based on ΔG. Therefore, the theoretical water electrolysis voltage is 1.23 V. Therefore, the state in which the voltage applied to the water electrolysis cell 2 is less than 1.23 V is the state of “to stop water electrolysis electric current supply”.

During the operation stop of the water electrolysis system 1, power from the main power supplier 56 is insufficiently supplied to the water electrolysis cell 2, and therefore, normal electric current that causes water electrolysis, water electrolysis electric current, does not flow, or reverse electric current can flow (except when power is supplied from the sub power supplier 58), through the water electrolysis cell 2. The electrical state of the water electrolysis cell 2 when the water electrolysis system 1 is in the operation stop also includes: the state where the water electrolysis cell 2 is applied with a voltage but normal electric current does not flow; and the state where normal electric current slightly flows such that potential change of the electrodes caused by the cross leakage described later cannot be suppressed.

The sub power supplier 58 can supply power to the power supply 4 independently of the main power supplier 56. The sub power supplier 58 can include, for example, a storage battery, system power, or the like. When the sub power supplier 58 includes a storage battery, the sub power supplier 58 may be charged by receiving power supply from the main power supplier 56. The sub power supplier 58 can supply power to the power supply 4 based on the control by the control device 10 while the water electrolysis system 1 is in the operation stop.

In the water electrolysis system 1 shown in FIG. 1, the main power supplier 56 and the sub power supplier 58 supply power to the common power supply 4. However, the present invention is not limited to the configuration. For example, each of the main power supplier 56 and the sub power supplier 58 may be provided with a separate power supply. Further, each of the main power supplier 56 and the sub power supplier 58 may have a power supply function. In this case, the independent power supply can be omitted. In addition, the sub power supplier 58 can also be configured by a charge supply mechanism in which a storage battery and a relay are combined. In this case, the control device 10 controls “on” and “off” of the relay. In the potential-maintaining mode as described later, the electric current supplied to the water electrolysis cell 2 is assumed to be less than 1/1000 of the rated electric current. Therefore, the water electrolysis system 1 may include a small power supply for the potential-maintaining mode instead of the sub power supplier 58.

The first flow mechanism 6 flows water to the oxygen generating electrode 12. The first flow mechanism 6 includes a first circulation tank 26, a first circulation path 28 (first circulation path forming structure), and a first circulation device 30. The first circulation tank 26 stores water that is supplied to the oxygen generating electrode 12 and recovered from the oxygen generating electrode 12. For example, the first circulation tank 26 stores pure water.

The first circulation tank 26 and the oxygen generating electrode 12 are connected through the first circulation path 28. The first circulation path 28 includes a forward path portion 28a to supply water from the first circulation tank 26 to the oxygen generating electrode 12, and a return path portion 28b to recover water from the oxygen generating electrode 12 to the first circulation tank 26. The forward path portion 28a and the return path portion 28b may be configured by a known pipe or the like. The first circulation device 30 is provided, for example, in the middle of the forward path portion 28a. By driving the first circulation device 30, water flows in the first circulation path 28 and circulates between the first circulation tank 26 and the oxygen generating electrode 12. As the first circulation device 30, for example, various pumps such as a gear pump and a cylinder pump, a natural flow type device, and the like can be used.

The first circulation tank 26 also functions as a gas-liquid separator. On the oxygen generating electrode 12, oxygen is generated by an electrode reaction. Therefore, the water recovered from the oxygen generating electrode 12 contains gaseous oxygen and dissolved oxygen. The gaseous oxygen is separated from the water in the first circulation tank 26 and taken out of the system. The water from which oxygen is separated is supplied to the oxygen generating electrode 12 again.

The second flow mechanism 8 flows water to the hydrogen generating electrode 16. The second flow mechanism 8 includes a second circulation tank 32, a second circulation path 34 (second circulation path forming structure), and a second circulation device 36. The second circulation tank 32 stores water that is supplied to the hydrogen generating electrode 16 and recovered from the hydrogen generating electrode 16. For example, the second circulation tank 32 stores pure water.

The second circulation tank 32 and the hydrogen generating electrode 16 are connected through the second circulation path 34. The second circulation path 34 includes a forward path portion 34a to supply water from the second circulation tank 32 to the hydrogen generating electrode 16, and a return path portion 34b to recover water from the hydrogen generating electrode 16 to the second circulation tank 32. The forward path portion 34a and the return path portion 34b may be configured by a known pipe or the like. The second circulation device 36 is provided, for example, in the middle of the forward path portion 34a. By driving the second circulation device 36, water flows in the second circulation path 34 and circulates between the second circulation tank 32 and the hydrogen generating electrode 16. As the second circulation device 36, for example, various pumps such as a gear pump and a cylinder pump, a natural flow type device, and the like can be used.

The second circulation tank 32 also functions as a gas-liquid separator. On the hydrogen generating electrode 16, hydrogen is generated by an electrode reaction. Therefore, the water recovered from the hydrogen generating electrode 16 contains gaseous hydrogen and dissolved hydrogen. The gaseous hydrogen is separated from the water in the second circulation tank 32 and taken out of the system. The water from which hydrogen is separated is supplied to the hydrogen generating electrode 16 again. When the water electrolysis cell 2 is a PEM type water electrolysis cell, the second flow mechanism 8 can be omitted. In this case, a pipe to take out hydrogen gas to the outside of the system is connected to the hydrogen generating electrode 16.

The control device 10 adjusts the potential of the oxygen generating electrode 12 and the hydrogen generating electrode 16 by controlling electric current supply to the water electrolysis cell 2. The control device 10 is realized by an element or a circuit such as a CPU or a memory for computers as the hardware configuration, and is realized by a computer program or the like as the software configuration, and is illustrated as functional blocks realized by cooperation thereof in FIG. 1. It should be understood by those skilled in the art that the functional blocks can be realized in various forms by a combination of hardware and software.

To the control device 10, for example, a signal indicating the voltage between the oxygen generating electrode 12 and the hydrogen generating electrode 16, that is, the voltage of the water electrolysis cell 2 is input from a detector 38 provided on the water electrolysis cell 2. Hereinafter, the voltage of the water electrolysis cell 2 is appropriately referred to as a cell voltage Vc. The detector 38 includes, for example, a known voltmeter, and can detect the cell voltage Vc by a known method. In this case, one terminal of the detector 38 is connected to the oxygen generating electrode 12, and the other terminal is connected to the hydrogen generating electrode 16, so that the cell voltage Vc is detected. The detector 38 transmits the detection result to the control device 10. The control device 10 can control the potential of each electrode using the cell voltage Vc as an index. FIG. 1 schematically illustrates the detector 38.

The detector 38 may detect the potential of the oxygen generating electrode 12 or the potential of the hydrogen generating electrode 16. In this case, a reference electrode is provided on the membrane 20. The reference electrode is held at a reference electrode potential. For example, the reference electrode is a reversible hydrogen electrode (RHE). Then, one terminal of the detector 38 is connected to the reference electrode, and the other terminal is connected to the electrode to be detected, and the potential of the electrode with respect to the reference electrode is detected. The detector 38 may include an electric current detector that detects electric current flowing between the oxygen generating electrode 12 and the hydrogen generating electrode 16.

Based on the detection result from the detector 38, the control device 10 controls the output of the power supply 4, the drive of the first circulation device 30 and the second circulation device 36, and the like during the operation of the water electrolysis system 1. In addition, the control device 10 controls the power supply 4, the first circulation device 30, the second circulation device 36, the sub power supplier 58, and the like while the water electrolysis system 1 is in the operation stop.

[Possible Electrode Deterioration during Operation Stop]

In the water electrolysis cell 2, cross leakage of gases occurs via the membrane 20. Specifically, a part of the oxygen gas generated on the oxygen generating electrode 12 passes through the membrane 20 and moves to the hydrogen generating electrode 16 side. In addition, a part of the hydrogen gas generated on the hydrogen generating electrode 16 passes through the membrane 20 and moves to the oxygen generating electrode 12 side. When water electrolysis electric current supply from the power supply 4 to the water electrolysis cell 2 is stopped and the operation of the water electrolysis system 1 is stopped, neither oxygen gas nor hydrogen gas are newly generated. Therefore, the oxygen gas concentration in the hydrogen generating electrode chamber 18 and the hydrogen gas concentration in the oxygen generating electrode chamber 14 increase due to the influence of the cross leakage, respectively.

When the operation of the water electrolysis system 1 is stopped, in some cases, the potential difference between the reduction reaction of oxygen on the oxygen generating electrode 12 and the oxidation reaction of hydrogen on the hydrogen generating electrode 16 becomes an electromotive force, and electric current in the direction opposite to that during electrolysis, a reverse electric current, flows through the first circulation path 28, the second circulation path 34, and the like. In particular, the reverse electric current easily flows when a plurality of the water electrolysis cells 2 are stacked and the water electrolysis cells 2 are connected by the first circulation path 28 or the second circulation path 34. As a result, in the water electrolysis cell 2, the following reverse reaction can occur.

O₂+4H⁺+4e⁻2H₂O Anode reaction after electrolysis stop

2H₂→4H⁺4e⁻ Cathode reaction after electrolysis stop:

When the cross leakage of gases or the reverse electric current occurs, oxygen in the oxygen generating electrode chamber 14 and hydrogen in the hydrogen generating electrode chamber 18 are consumed in an amount corresponding to an equal charge amount. That is, two hydrogen molecules are consumed for one oxygen molecule in the above-described reaction. When oxygen or hydrogen remaining in any of the electrode chambers is exhausted and the electric capacity of the electrode itself is consumed, the potential of both electrodes change to the oxidation-reduction potential of the electrode in which oxygen or hydrogen remains at that time. That is, when the operation of the water electrolysis system 1 is stopped, the potential of the oxygen generating electrode 12 and the hydrogen generating electrode 16 changes to the potential of the electrode having a larger total amount among the total amount of the oxidizing agent on the oxygen generating electrode 12 side and the total amount of the reducing agent on the hydrogen generating electrode 16 side.

The above-described oxidation-reduction potential is a potential when a reaction accompanied by a phase change or a valence change of the catalyst contained in the electrode is caused. Hereinafter, the reduction potential when the oxygen generating catalyst undergoes a reduction reaction accompanied by a phase change or a valence change is appropriately referred to as a reduction potential E_{AN}. The oxidation potential when the hydrogen generating catalyst undergoes an oxidation reaction accompanied by a phase change or a valence change is referred to as an oxidation potential E_{CA}. The reduction potential E_{AN} of the oxygen generating catalyst can be defined as a potential that is less than 1.23 V and the highest among the oxidation-reduction potentials of substances constituting the oxygen generating catalyst. The oxidation potential E_{CA} of the hydrogen generating catalyst can be defined as a potential that is more than 0 V and the lowest among the oxidation-reduction potentials of substances constituting the hydrogen generating catalyst.

The total amount of each of the oxidizing agent on the oxygen generating electrode 12 side and the reducing agent on the hydrogen generating electrode 16 side can be calculated as follows in terms of electrical amount (charge amount).

Total amount of oxidizing agent (electrical amount)=Electrode capacity of oxygen generating electrode+Number of reactive electrons×Faraday constant×Number of moles of oxygen in electrode chamber

Total amount of reducing agent (electrical amount)=Electrode capacity of hydrogen generating electrode+Number of reactive electrons×Faraday constant×Number of moles of hydrogen in electrode chamber

In the above formula, the number of moles of oxygen is the total number of moles of oxygen dissolved in water and oxygen in a gas state. Similarly, the number of moles of hydrogen is the total number of moles of hydrogen dissolved in water and hydrogen in a gas state.

In the water electrolysis cell 2 of the embodiment, the potential of the oxygen generating electrode 12 is about 1.23 V (vs. RHE), and the potential of the hydrogen generating electrode 16 is about 0 V (vs. RHE) during the operation or immediately after the operation stop of the water electrolysis system 1. When cross leakage of gases or reverse electric current occurs during the operation stop of the water electrolysis system 1, the potential of the oxygen generating electrode 12 may decrease to the reduction potential E_{AN} or less, or the potential of the hydrogen generating electrode 16 may increase to the oxidation potential E_{CA} or more.

When such a potential change occurs, the catalyst changes in its valence, elutes, aggregates, or the like, progressively deteriorating the electrode. As the electrode is progressively deteriorated, the electrolysis overvoltage of the water electrolysis cell 2 increases, increasing the electric energy required to generate hydrogen per unit mass. When the electric energy required for hydrogen generation increases and the hydrogen generation efficiency falls below a predetermined value, the water electrolysis cell 2 reaches the end of its life. The life due to electrode deterioration is based on, for example, a case where the voltage of the water electrolysis cell 2 during electrolysis (in the case of an electric current density of 1 A/cm²) is increased by 20%. In the PEM type water electrolysis cell, when pure water is supplied to each of the oxygen generating electrode 12 and the hydrogen generating electrode 16, electrode deterioration may occur mainly due to cross leakage of gases.

[Measures against Electrode Deterioration]

The control device 10 according to the embodiment implements the potential-maintaining mode as described below to suppress electrode deterioration occurring during the operation stop. That is, the control device 10 supplies electric current to at least one water electrolysis cell 2 during the operation stop of the water electrolysis system 1, and adjusts the potential of at least one of the oxygen generating electrode 12 and the hydrogen generating electrode 16. The phrase “at least one water electrolysis cell 2” as used herein mainly means a single water electrolysis cell 2 or a water electrolysis stack in which two or more water electrolysis cells 2 are stacked. That is, when the water electrolysis system 1 includes only one water electrolysis cell 2, the control device 10 implements the potential-maintaining mode to the water electrolysis cell 2. When the water electrolysis system 1 includes the water electrolysis stack (a plurality of the water electrolysis cells 2), the control device 10 implements the potential-maintaining mode to the plurality of the water electrolysis cells 2 constituting the water electrolysis stack. The potential-maintaining mode may be implemented only to one or some of the water electrolysis cells 2 among the plurality of the water electrolysis cells 2 constituting the water electrolysis stack. During the operation stop of the water electrolysis system 1, the control device 10 according to the embodiment supplies electric current to the water electrolysis cell 2 so that the potential of the oxygen generating electrode 12 is higher than the reduction potential E_{AN} of the oxygen generating catalyst and the potential of the hydrogen generating electrode 16 is lower than the oxidation potential E_{CA} of the hydrogen generating catalyst. As an example, the control device 10 adjusts the potential of each electrode by controlling electric current supply to the water electrolysis cell 2 by using power derived from the sub power supplier 58.

During the operation stop of the water electrolysis system 1, when the water electrolysis cell 2 is supplied with electric current and the potential of the oxygen generating electrode 12 is set to higher than the reduction potential E_{AN}, a valence change of the oxygen generating catalyst or the like is suppressed, and thereby deterioration of the oxygen generating electrode 12 can be suppressed. In addition, when the potential of the hydrogen generating electrode 16 is set to lower than the oxidation potential E_{CA}, a valence change of the hydrogen generating catalyst or the like is suppressed, and thereby deterioration of the hydrogen generating electrode 16 can be suppressed. Accordingly, the durability of the water electrolysis system 1 can be improved.

During the operation of the water electrolysis system 1, the voltage and potential are maintained at the electrolysis voltage or the electrolysis potential. Therefore, the operation stop of the water electrolysis system 1 can be grasped based on a change in voltage or potential detected by the detector 38. Alternatively, the control device 10 can detect the operation stop of the water electrolysis system 1 by receiving a power supply stop signal from the main power supplier 56. The control device 10 is driven by another power supply (not illustrated).

### [Deterioration of Membrane]

As a result of intensive studies, the present inventors have found that not only the electrodes but also the membrane 20 can deteriorate during the operation and the operation stop of the water electrolysis system 1. That is, when oxygen gas cross-leaks from the oxygen generating electrode 12 side to the hydrogen generating electrode 16 side, the moved oxygen can react with hydrogen remaining on the hydrogen generating electrode 16 side to generate hydrogen peroxide. In the water in the hydrogen generating electrode chamber 18, iron ions eluted from a pipe or the like constituting the second circulation path 34 may be dissolved. Therefore, hydroxy radicals can be generated from hydrogen peroxide with iron ions as a catalyst. When hydroxy radicals are generated, the membrane 20 may be decomposed and deteriorated by the hydroxy radicals.

At this time, the amount of hydroxy radicals generated in the hydrogen generating electrode chamber 18 depends on the oxygen gas concentration in the hydrogen generating electrode chamber 18. The oxygen gas concentration in the hydrogen generating electrode chamber 18 is determined by the amount of oxygen gas cross leakage from the oxygen generating electrode 12 side to the hydrogen generating electrode 16 side and the amount of hydrogen gas generated on the hydrogen generating electrode 16. The amount of oxygen gas cross leakage is governed by the concentration gradient between the oxygen concentration at the interface of the oxygen generating electrode 12 and the oxygen concentration at the interface of the hydrogen generating electrode 16. As water electrolysis electric current increases, the oxygen concentration at the interface of the oxygen generating electrode 12 also increases. Then, the oxygen concentration at the interface of the oxygen generating electrode 12 converges at a certain electric current value or higher. Along with this, the amount of oxygen gas cross leakage also converges. On the other hand, as water electrolysis electric current increases, the amount of hydrogen gas generated on the hydrogen generating electrode 16 also increases. Therefore, the influence of oxygen gas cross leakage is reduced in the gas composition in the hydrogen generating electrode chamber 18. That is, the oxygen gas concentration in the hydrogen generating electrode chamber 18 increases as the water electrolysis electric current value increase, reaches a maximum point at a certain electric current value, and decreases as the electric current value further increases. Therefore, the low power operation of the water electrolysis system 1 may cause deterioration of the membrane 20. The electric current value reaching the maximum point can change together with the components of the water electrolysis system 1.

### [Measures Against Membrane Deterioration]

In response to this, the control device 10 according to the embodiment, in the potential-maintaining mode, supplies electric current to the water electrolysis cell 2 so that the potential of the oxygen generating electrode 12 is lower than the oxygen generating potential. The oxygen generating potential means a potential at which the anode reaction proceeds on the oxygen generating electrode 12, that is, a potential at which oxygen is generated. As described above, when the potential of the oxygen generating electrode 12 is less than the oxygen generating potential during the operation stop of the water electrolysis system 1, oxygen generation can be suppressed on the oxygen generating electrode 12 to reduce the amount of oxygen cross-leaking to the hydrogen generating electrode 16 side. As a result, it is possible to suppress generation of hydrogen peroxide and thus hydroxy radicals and to suppress deterioration of the membrane 20. As described above, the durability of the water electrolysis system 1 can be improved.

Preferably, the control device 10, in the potential-maintaining mode, supplies electric current to the water electrolysis cell 2 so that the potential of the hydrogen generating electrode 16 is higher than the hydrogen generating potential. The hydrogen generating potential means a potential at which the cathode reaction proceeds on the hydrogen generating electrode 16, that is, a potential at which hydrogen is generated. Due to the height of the potential of the oxygen generating electrode 12, even if hydrogen gas cross-leaks from the hydrogen generating electrode 16 side to the oxygen generating electrode 12 side, hydrogen peroxide generation reaction hardly occurs. However, it is not impossible that hydrogen peroxide is generated on the oxygen generating electrode 12 side. In addition, the hydrogen cross leakage itself causes a potential change of the oxygen generating electrode 12. Therefore, it is desirable that the potential of the hydrogen generating electrode 16 is set to higher than the hydrogen generating potential to reduce the amount of hydrogen cross-leaking toward the oxygen generating electrode 12 side. This makes it possible to further suppress deterioration of the membrane 20.

The amount of oxygen cross-leaking from the oxygen generating electrode 12 side to the hydrogen generating electrode 16 side via the membrane 20 per unit time is defined as X mol/s (mol/sec), and the amount of hydrogen cross-leaking from the hydrogen generating electrode 16 side to the oxygen generating electrode 12 side via the membrane 20 per unit time is defined as Y mol/s. At this time, when the potential of the oxygen generating electrode 12 changes in the operation stop under no implementation of the potential-maintaining mode, the control device 10 preferably performs control so that electric current at Y×2×96485 A or more is supplied to the water electrolysis cell 2 in the potential-maintaining mode. When the potential of the hydrogen generating electrode 16 changes in the operation stop under no implementation of the potential-maintaining mode, the control device 10 preferably performs control so that electric current at X×4×96485 A or more is supplied to the water electrolysis cell 2 in the potential-maintaining mode.

When the potential of the oxygen generating electrode 12 changes under no implementation of potential adjustment for the electrode during the operation stop of the water electrolysis system 1, hydrogen cross leakage greatly affects deterioration of the durability of the water electrolysis system 1. Therefore, it is desirable to reduce hydrogen that has moved to the oxygen generating electrode 12 side. The hydrogen moved to the oxygen generating electrode 12 side can be consumed by the following reaction on the oxygen generating electrode 12 side.

H₂→2H⁺+2e⁻ Consumption reaction of hydrogen

When Y [mol/s] of hydrogen cross-leaks per unit time, 2× Y [mol/s] of electrons is required to consume the entire hydrogen. When this is converted into an electric current value, Y [mol/s]×2×96485 [sA/mol]=Y×2×96485 [A] is obtained. The number 96485 denotes the Faraday constant. Therefore, when the potential of the oxygen generating electrode 12 tends to change during the operation stop of the water electrolysis system 1, the potential change and deterioration of the oxygen generating electrode 12 can be suppressed, and the durability of the water electrolysis system 1 can be enhanced, by supplying electric current at Y×2×96485 A or more to the water electrolysis cell 2.

When the potential of the hydrogen generating electrode 16 changes under no implementation of potential adjustment for the electrode during the operation stop of the water electrolysis system 1, oxygen cross leakage greatly affects deterioration of the durability of the water electrolysis system 1. Therefore, it is desirable to reduce oxygen that has moved to the hydrogen generating electrode 16 side. The oxygen moved to the hydrogen generating electrode 16 side can be consumed by the following reaction on the hydrogen generating electrode 16 side.

O₂+4H⁺+4e⁻→2H₂O Consumption reaction of oxygen:

When X [mol/s] of oxygen cross-leaks per unit time, 4×X [mol/s] of electrons is required to consume the entire oxygen. When this is converted into an electric current value, X [mol/s]×4×96485 [sA/mol]=X×4×96485 [A] is obtained. Therefore, when the potential of the hydrogen generating electrode 16 tends to change during the operation stop of the water electrolysis system 1, the potential change and deterioration of the hydrogen generating electrode 16 can be suppressed, and the durability of the water electrolysis system 1 can be enhanced, by supplying electric current at X×4×96485 A or more to the water electrolysis cell 2.

The amount of cross-leaking oxygen per unit time (X mol/sec) and the amount of cross-leaking hydrogen per unit time (Y mol/sec) are determined according to the material of the membrane 20 and the like, and can be grasped in advance. In addition, it is also possible to artificially control which electrode potential changes during the operation stop. That is, which electrode potential changes depends on the magnitude of the total amount of the oxidizing agent on the oxygen generating electrode 12 side and the total amount of the reducing agent on the hydrogen generating electrode 16 side at the time of the operation stop of the water electrolysis system 1. Therefore, at the time of entering the operation stop, measures are performed such as shifting the drive stop timing of the first flow mechanism 6 and the second flow mechanism 8, flowing an inert gas to one electrode side, or pressurizing one electrode chamber side. Thereby, one of the oxidizing agent and the reducing agent can be always in larger amount at the time of the operation stop. As a result, the control device 10 can grasp in advance the electrode whose potential changes when the potential adjustment is not performed during the operation stop.

The electric current supply control implemented in the potential-maintaining mode is not limited to the above. For example, the control device 10 may supply electric current to the water electrolysis cell 2 so that the cell voltage of the water electrolysis cell 2 is maintained at a predetermined value or higher during the operation stop. The predetermined value is, for example, 0.1 V or higher. In addition, when the cell voltage falls below the predetermined value, the control device 10 may supply water electrolysis electric current to the water electrolysis cell 2 in a pulse manner to maintain the potential of each electrode.

[Selection of Mode Implemented during Operation Stop]

As a result of intensive studies, the present inventors have found that, depending on the use state of the water electrolysis cell 2, the durability of the water electrolysis system 1 can be further enhanced when the complete stop mode to shut out electric current supply to the water electrolysis cell 2 is implemented, as compared with implementation of the potential-maintaining mode. The complete stop mode is a mode in which no electric current is supplied to the water electrolysis cell 2 from any of the power supply 4, the main power supplier 56, and the sub power supplier 58. Therefore, in the embodiment, the control device 10 can implement the electric current-maintaining mode and the complete stop mode, and when the operation stop of the water electrolysis system 1 is detected, which mode to implement is determined according to the use state of the water electrolysis cell 2. Thus, the durability of the water electrolysis system 1 can be further improved by selectively using the potential-maintaining mode and the complete stop mode.

Examples of the use state of the water electrolysis cell 2 include the duration time of the operation stop, the first deterioration rate of the water electrolysis cell 2 when the complete stop mode is implemented, and the second deterioration rate of the water electrolysis cell 2 when the potential-maintaining mode is implemented. Therefore, as an example, the control device 10 determines which of the modes is implemented based on the duration time of the operation stop, the first deterioration rate, and the second deterioration rate.

When an operation plan defining the operation time and the stop time of the water electrolysis system 1 is created, the duration time of the operation stop can be grasped based on the operation plan. The duration time of the operation stop can also be predicted according to the timing of the operation stop, for example. For example, in a case where the main power supplier 56 is constituted by the solar power generator 24, when the operation of the water electrolysis system 1 is stopped after sunset time, it can be predicted that the duration time of the operation stop is until sunrise time of the next day. When the operation of the water electrolysis system 1 is stopped before sunset time, the duration time of the operation stop can be set to a predetermined time in advance according to the weather on that day or the like. As an example, the duration time of the operation stop is set to a predetermined first time when the weather on that day is sunny, and is set to a second time longer than the first time when the weather is cloudy or rainy. The control device 10 stores in advance each piece of information of sunset time, sunrise time, and weather. The control device 10 can also update each piece of information over time.

In addition, the electrode of the water electrolysis cell 2 deteriorates every time the operation of the water electrolysis system 1 is stopped, and the voltage required to flow the equal electric current increases. Therefore, the first deterioration rate when the complete stop mode is implemented can be regarded as an increase amount of the voltage per operation stop [V/time]. The number of times of the operation stop is defined as the number of times the cell voltage falls below a predetermined voltage (for example, 1.23 V) due to the operation stop. In addition, the electrode of the water electrolysis cell 2 may progressively deteriorate over time during the implementation of the complete stop mode. Therefore, the first deterioration rate includes not only the above-mentioned deterioration rate per operation stop but also the deterioration rate per duration time of the complete stop mode. The deterioration rate per duration time can be regarded as an increase amount of the voltage per duration time [V/h]. In addition, even when the electrode of the water electrolysis cell 2 is maintained at the potential in the potential-maintaining mode, the electrode can progressively deteriorate over time to some extent. Therefore, the second deterioration rate when the potential-maintaining mode is implemented can be regarded as an increase amount of the voltage per duration time of the potential-maintaining mode [V/h].

The control device 10 stores the first deterioration rate and the second deterioration rate, each of which is used for mode-determination. The first deterioration rate and the second deterioration rate can be grasped in advance by performing a preliminary test where the complete stop mode and the potential-maintaining mode are implemented to the water electrolysis cell 2. In addition, the first deterioration rate and the second deterioration rate can change along with the use of the water electrolysis cell 2. Therefore, the control device 10 preferably updates at least one of the stored first deterioration rate and second deterioration rate over time. Under the use condition of the water electrolysis system 1, the control device 10 can measure the deterioration rate of the water electrolysis cell 2 when each mode is implemented to acquire a new deterioration rate.

Depending on the length of the duration time of the operation stop, which mode can further suppress the deterioration of the electrode is changed. As an example, where the duration time of the operation stop is “a [h]”, the deterioration rate per operation stop in the first deterioration rate is “b [V/number of stops]”, the deterioration rate per duration time of the complete stop mode in the first deterioration rate is “h [V/h]”, and the second deterioration rate is “c [V/h]”, the control device 10 implements the complete stop mode in a case of b+a×h<a×c. The potential-maintaining mode is implemented in a case of b+a×h>a×c. The complete stop mode or the potential-maintaining mode is implemented in a case of b+a×h=a×c. That is, when the duration time “a” of the operation stop is relatively long and the deterioration amount (a×c) of the electrode due to the implementation of the potential-maintaining mode exceeds the deterioration amount (b+a×h) of the electrode due to the implementation of the complete stop mode, the complete stop mode is selected and implemented. On the other hand, when the duration time “a” of the operation stop is relatively short and the deterioration amount of the electrode due to the implementation of the potential-maintaining mode is less than the deterioration amount of the electrode due to the implementation of the complete stop mode, the potential-maintaining mode is selected and implemented. Accordingly, the durability of the water electrolysis system 1 can be improved.

In addition, which mode is implemented may be selected in consideration of not only the voltage increase (electrode deterioration) but also the operation cost of the water electrolysis system 1. For example, the duration time of the operation stop is “a [h]”, the deterioration rate per operation stop in the first deterioration rate is “b [V/number of stops]”, the deterioration rate per duration time of the complete stop mode in the first deterioration rate is “h [V/h]”, the second deterioration rate is “c [V/h]”, power consumption when the potential-maintaining mode is implemented is “d [kW]”, a voltage increase that is allowable for the water electrolysis cell 2 is “e [V]”, the price of the water electrolysis cell 2 is “f [yen]”, and the electricity charge per electric energy consumption is “g [yen/kWh]”. At this time, the control device 10 implements the complete stop mode in a case of {(b+a×h)/e}× f<a×{(c/e)× f+d×g}. The potential-maintaining mode is implemented in a case of {(b+a×h)/e}×f>a×{(c/e)×f+d×g}. The complete stop mode or the potential-maintaining mode is implemented in a case of {(b+a×h)/e}×f=a×{(c/e)×f+d×g}.

That is, regarding the complete stop mode, the ratio of the present voltage increase to the allowable voltage increase “e” ((b+a×h)/e) is multiplied by the price “f” of the water electrolysis cell 2 to obtain the device depreciation charge ({(b+a×h)/e}×f), which is the total cost required when the complete stop mode is implemented. On the other hand, regarding the potential-maintaining mode, electricity charge per hour (d×g) required to implement the mode is added to the device depreciation charge ((c/e)×f) ((c/e)×f+d×g), which is multiplied by the operation stop-maintaining time “a” (a×{(c/e)×f+d×g)}), thereby obtaining the total cost required when the potential-maintaining mode is implemented. Then, the control device 10 selects and implements the complete stop mode when the total cost of the complete stop mode is less than the total cost of the potential-maintaining mode, and selects and implements the potential-maintaining mode when the total cost of the complete stop mode exceeds the total cost of the potential-maintaining mode. As a result, it is possible to improve the operation efficiency of the water electrolysis system 1 while improving the durability of the water electrolysis system 1.

The power consumption “d”, the allowable voltage increase “e”, the price “f” of the water electrolysis cell 2, and the electricity charge “g” can be set in advance and stored in the control device 10. The allowable voltage increase “e” is determined according to the life of the water electrolysis cell 2 described above, for example. The electricity charge “g” is preferably an electricity charge during the operation stop of the water electrolysis system 1. Each piece of information may be updated over time as needed.

The embodiments may be identified by the items described below.

### Item 1

A control device (10) for a water electrolysis cell (2) that has: an oxygen generating electrode (12) containing an oxygen generating catalyst; a hydrogen generating electrode (16) containing a hydrogen generating catalyst; and a membrane (20) that separates the oxygen generating electrode (12) and the hydrogen generating electrode (16), and electrolyzes water to generate oxygen on the oxygen generating electrode (12) and generate hydrogen on the hydrogen generating electrode (16),
the control device (10) including:
a potential-maintaining mode where at least one of the water electrolysis cell(s) (2) is supplied with electric current; and
a complete stop mode where the water electrolysis cell (2) is shut out from electric current supply,
each of the modes is optionally implemented during an operation stop where the water electrolysis cell (2) stops hydrogen supply,
wherein which of the modes is implemented is determined based on a duration time of the operation stop, a first deterioration rate of the water electrolysis cell (2) when the complete stop mode is implemented, and a second deterioration rate of the water electrolysis cell (2) when the potential-maintaining mode is implemented.

### Item 2

The control device (10) for a water electrolysis cell (2) according to item 1, wherein, in the potential-maintaining mode, the water electrolysis cell (2) is supplied with electric current so that a potential of the oxygen generating electrode (12) is higher than a reduction potential of the oxygen generating catalyst and a potential of the hydrogen generating electrode (16) is lower than an oxidation potential of the hydrogen generating catalyst.

### Item 3

The control device (10) for a water electrolysis cell (2) according to item 2, wherein, in the potential-maintaining mode, the water electrolysis cell (2) is supplied with electric current so that a potential of the oxygen generating electrode (12) is lower than an oxygen generating potential.

### Item 4

The control device (10) for a water electrolysis cell (2) according to any one of items 1 to 3, wherein the first deterioration rate includes: a deterioration rate per operation stop; and a deterioration rate per duration time of the complete stop mode, and, where
the duration time of the operation stop is “a [h]”,
the deterioration rate per operation stop is “b [V/number of stops]”,
the deterioration rate per duration time is “h [V/h]”, and
the second deterioration rate is “c [V/h]”,
the complete stop mode is implemented in a case of b+a×h<a×c; the potential-maintaining mode is implemented in a case of b+a×h>a×c; and the complete stop mode or the potential-maintaining mode is implemented in a case of b+a×h=a×c.

### Item 5

The control device (10) for a water electrolysis cell (2) according to any one of items 1 to 3, wherein the first deterioration rate includes: a deterioration rate per operation stop; and a deterioration rate per duration time of the complete stop mode, and, where
the duration time of the operation stop is “a [h]”,
the deterioration rate per operation stop is “b [V/number of stops]”,
the deterioration rate per duration time is “h [V/h]”,
the second deterioration rate is “c [V/h]”,
power consumption when the potential-maintaining mode is implemented is “d [kW]”,
a voltage increase that is allowable for the water electrolysis cell (2) is “e [V]”,
a price of the water electrolysis cell (2) is “f [yen]”, and
an electricity charge per electric energy consumption is “g [yen/kWh]”,
the complete stop mode is implemented in a case of {(b+a×h)/e}×f<a×{(c/e)×f+d×g}; the potential-maintaining mode is implemented in a case of {(b+a×h)/e}×f>a×{(c/e)×f+d×g}; and the complete stop mode or the potential-maintaining mode is implemented in a case of {(b+a×h)/e}×f=a×{(c/e)×f+d×g}.

### Item 6

The control device (10) for a water electrolysis cell (2) according to any one of items 1 to 5, wherein the first deterioration rate and the second deterioration rate, each of which is used for mode-determination, are stored, and at least one of the stored first deterioration rate and second deterioration rate is updated over time.

### Item 7

A water electrolysis system (1) including:
at least one water electrolysis cell (2) that has: an oxygen generating electrode (12) containing an oxygen generating catalyst; a hydrogen generating electrode (16) containing a hydrogen generating catalyst; and a membrane (20) that separates the oxygen generating electrode (12) and the hydrogen generating electrode (16), and electrolyzes water to generate oxygen on the oxygen generating electrode (12) and generate hydrogen on the hydrogen generating electrode (16); and
the control device (10) for a water electrolysis cell (2) according to any one of items 1 to 6.

### Item 8

A control method for a water electrolysis cell (2) that has: an oxygen generating electrode (12) containing an oxygen generating catalyst; a hydrogen generating electrode (16) containing a hydrogen generating catalyst; and a membrane (20) that separates the oxygen generating electrode (12) and the hydrogen generating electrode (16), and electrolyzes water to generate oxygen on the oxygen generating electrode (12) and generate hydrogen on the hydrogen generating electrode (16),
the control method including: determining which of:
a potential-maintaining mode where at least one of the water electrolysis cell(s) (2) is supplied with electric current; and
a complete stop mode where the water electrolysis cell (2) is shut out from electric current supply
is implemented during an operation stop where the water electrolysis cell (2) stops hydrogen supply, based on a duration time of the operation stop, a first deterioration rate of the water electrolysis cell (2) when the complete stop mode is implemented, and a second deterioration rate of the water electrolysis cell (2) when the potential-maintaining mode is implemented.

1. A control device for a water electrolysis cell that has: an oxygen generating electrode containing an oxygen generating catalyst; a hydrogen generating electrode containing a hydrogen generating catalyst; and a membrane that separates the oxygen generating electrode and the hydrogen generating electrode, and electrolyzes water to generate oxygen on the oxygen generating electrode and generate hydrogen on the hydrogen generating electrode,
the control device comprising:
a potential-maintaining mode where at least one of the water electrolysis cell(s) is supplied with electric current; and
a complete stop mode where the water electrolysis cell is shut out from electric current supply,
each of the modes is optionally implemented during an operation stop where the water electrolysis cell stops hydrogen supply,
wherein which of the modes is implemented is determined based on a duration time of the operation stop, a first deterioration rate of the water electrolysis cell when the complete stop mode is implemented, and a second deterioration rate of the water electrolysis cell when the potential-maintaining mode is implemented.

2. The control device for a water electrolysis cell according to claim 1,
wherein, in the potential-maintaining mode, the water electrolysis cell is supplied with electric current so that a potential of the oxygen generating electrode is higher than a reduction potential of the oxygen generating catalyst and a potential of the hydrogen generating electrode is lower than an oxidation potential of the hydrogen generating catalyst.

3. The control device for a water electrolysis cell according to claim 2, wherein, in the potential-maintaining mode, the water electrolysis cell is supplied with electric current so that a potential of the oxygen generating electrode is lower than an oxygen generating potential.

4. The control device for a water electrolysis cell according to claim 1, wherein the first deterioration rate includes: a deterioration rate per operation stop; and a deterioration rate per duration time of the complete stop mode, and, where
the duration time of the operation stop is “a [h]”,
the deterioration rate per operation stop is “b [V/number of stops]”,
the deterioration rate per duration time is “h [V/h]”, and
the second deterioration rate is “c [V/h]”,
the complete stop mode is implemented in a case of b+a×h<a×c; the potential-maintaining mode is implemented in a case of b+a×h>a×c; and the complete stop mode or the potential-maintaining mode is implemented in a case of b+a×h=a×c.

5. The control device for a water electrolysis cell according to claim 1, wherein the first deterioration rate includes: a deterioration rate per operation stop; and a deterioration rate per duration time of the complete stop mode, and, where
the duration time of the operation stop is “a [h]”,
the deterioration rate per operation stop is “b [V/number of stops]”,
the deterioration rate per duration time is “h [V/h]”,
the second deterioration rate is “c [V/h]”,
power consumption when the potential-maintaining mode is implemented is “d [kW]”,
a voltage increase that is allowable for the water electrolysis cell is “e [V]”,
a price of the water electrolysis cell is “f [yen]”, and
an electricity charge per electric energy consumption is “g [yen/kWh]”,
the complete stop mode is implemented in a case of {(b+a×h)/e}×f<a×{(c/e)×f+d×g}; the potential-maintaining mode is implemented in a case of {(b+a×h)/e}×f>a×{(c/e)×f+d×g}; and the complete stop mode or the potential-maintaining mode is implemented in a case of {(b+a×h)/e}×f=a×{(c/e)×f+d×g}.

6. The control device for a water electrolysis cell according to claim 1, wherein
the first deterioration rate and the second deterioration rate, each of which is used for mode-determination, are stored, and
at least one of the stored first deterioration rate and second deterioration rate is updated over time.

7. A water electrolysis system comprising:
at least one water electrolysis cell that has: an oxygen generating electrode containing an oxygen generating catalyst; a hydrogen generating electrode containing a hydrogen generating catalyst; and a membrane that separates the oxygen generating electrode and the hydrogen generating electrode, and electrolyzes water to generate oxygen on the oxygen generating electrode and generate hydrogen on the hydrogen generating electrode; and
the control device for a water electrolysis cell according to claim 1.

8. A control method for a water electrolysis cell that has: an oxygen generating electrode containing an oxygen generating catalyst; a hydrogen generating electrode containing a hydrogen generating catalyst; and a membrane that separates the oxygen generating electrode and the hydrogen generating electrode, and electrolyzes water to generate oxygen on the oxygen generating electrode and generate hydrogen on the hydrogen generating electrode,
the control method comprising: determining which of:
a potential-maintaining mode where at least one of the water electrolysis cell(s) is supplied with electric current; and
a complete stop mode where the water electrolysis cell is shut out from electric current supply
is implemented during an operation stop where the water electrolysis cell stops hydrogen supply, based on a duration time of the operation stop, a first deterioration rate of the water electrolysis cell when the complete stop mode is implemented, and a second deterioration rate of the water electrolysis cell when the potential-maintaining mode is implemented.
